(19) United States
(12) Patent Application Publication
(10) Pub. No.: US 2015/0278823 A1
(43) Pub. Date: Oct. 1, 2015

(54) CLASSIFICATION OF DEVICE PROBLEMS OF CUSTOMER PREMISES DEVICES

(71) Applicant: Alcatel-Lucent USA Inc., Murray Hill, NJ (US)

(72) Inventors: Dan Kushnir, Springfield, NJ (US); Yue Geng, Wheeling, IL (US); Ahmet Akyamac, Bridgewater, NJ (US); Chitra Phadke, Basking Ridge, NJ (US); Huseyin Uzunalioglu, Millington, NJ (US)

(73) Assignee: Alcatel-Lucent USA Inc., Murray Hill, NJ (US)

(21) Appl. No.: 14/242,161

(22) Filed: Apr. 1, 2014

(51) Int. Cl. G06Q 30/00; G06F 17/27; G06F 17/30

(52) U.S. Cl. CPC G06Q 30/016; G06F 17/30705; G06F 17/277

(57) ABSTRACT

A capability for classifying a device problem of a customer premises device of a customer is presented. The capability for classifying a device problem of a customer premises device of a customer may include receiving customer trouble ticket information of a trouble ticket associated with a customer, receiving customer device measurement information for a customer premises device of the customer, and classifying a device problem of the customer premises device based on text mining of the customer trouble ticket information and based on the customer device measurement information.

### TECHNICAL FIELD

The disclosure relates generally to customer premises devices and, more specifically but not exclusively, to classification of device problems of customer premises devices.

### BACKGROUND

The correct classification of devices problems of customer premises devices is important for several reasons. For example, correct classification of customer premises device problems generally improves the problem ticket resolution workflow, enables customer care teams and management levels to leverage correct statistics on customer premises device problems in order to improve the performance of the customer premises devices as well as communication networks via which the customer premises devices communicate, and may be used to train prediction models for predicting customer premises device problems before the customer premises device problems actually occur. Disadvantageously, however, existing methods for classification of devices problems of customer premises devices are often unreliable.

### SUMMARY OF EMBODIMENTS

Various deficiencies in the prior art are addressed by embodiments for classifying a device problem of a customer premises device of a customer.

In at least some embodiments, an apparatus includes a processor and a memory communicatively connected to the processor, where the processor is configured to receive customer trouble ticket information of a trouble ticket associated with a customer, receive customer device measurement information for a customer premises device of the customer, and classify a device problem of the customer premises device based on text mining of the customer trouble ticket information and based on the customer device measurement information.

In at least some embodiments, a method includes using a processor and a memory for receiving customer trouble ticket information of a trouble ticket associated with a customer, receiving customer device measurement information for a customer premises device of the customer, and classifying a device problem of the customer premises device based on text mining of the customer trouble ticket information and based on the customer device measurement information.

In at least some embodiments, a computer-readable storage medium stores instructions which, when executed by a computer, cause the computer to perform a method including receiving customer trouble ticket information of a trouble ticket associated with a customer, receiving customer device measurement information for a customer premises device of the customer, and classifying a device problem of the customer premises device based on text mining of the customer trouble ticket information and based on the customer device measurement information.

### BRIEF DESCRIPTION OF THE DRAWINGS

The teachings herein can be readily understood by considering the detailed description in conjunction with the accompanying drawings, in which:

FIG. 1 depicts an exemplary communication system including a device problem classification system that is configured to support classification of device problems of customer premises devices

FIG. 2 depicts an exemplary implementation of the device problem classification system of FIG. 1;

FIG. 3 depicts an embodiment of a method for performing device problem classification for one or more customer premises devices of a customer based on text mining of customer trouble ticket information of a trouble ticket for the customer;

FIG. 4 depicts an embodiment of a method for performing device problem classification for one or more customer premises devices of a customer based on text mining of customer trouble ticket information of a trouble ticket for the customer and classification of customer device measurement information from one or more customer premises devices of the customer;

FIG. 5 depicts an embodiment of a method for performing device problem classification for one or more customer premises devices of a customer based on fusion of trouble ticket information and device measurement information;

FIG. 6 depicts an embodiment of a method for performing text mining of trouble ticket information based on training of regular expressions from historical trouble ticket information;

FIG. 7 depicts an embodiment of a method for training regular expressions based on historical trouble ticket information;

FIGS. 8A and 8B depict an exemplary corpus of trouble ticket information for a set of trouble tickets;

FIG. 9 depicts an exemplary trouble ticket narrative of a trouble ticket; and

FIG. 10 depicts a high-level block diagram of a computer suitable for use in performing functions presented herein.

To facilitate understanding, identical reference numerals have been used, where possible, to designate identical elements common to the figures.

### DETAILED DESCRIPTION OF EMBODIMENTS

The use of customer premises devices to receive communications services of service providers at customer premises locations is ubiquitous. For example, individuals and families use various types of customer premises devices to receive communications services at home, businesses use customer premises devices to receive communications services at business locations, and so forth. In general, communications services provided to customer premises may include telephone service, television service, Internet access service, or the like, and, similarly, customer premises devices may include devices and terminals such as routers, modems, switches, residential gateways, set-top boxes, and the like. While the reliability of such customer premises devices, as well as services provided via such customer premises devices is typically good, various problems may arise, with the customer premises devices or networks delivering services to the customer premises devices, which cause problems with consumption of services via customer premises devices. For example, a customer at a customer premises may experience degradation or loss of television service, degradation or loss of Internet access, or the like. In many cases, upon experiencing a problem or potential problem, the customer will report the problem or potential problem to the service provider providing the impacted service (e.g., via a telephone call to a customer care center, via online submission of a trouble report, or the like). The service provider will then attempt to determine the cause of the problem or potential problem and to resolve the problem or potential problem.

In many cases, in which the problem or potential problem is with one of the customer premises devices supporting the impacted communications service, the service provider will attempt to classify the device problem of the customer premises device. As discussed above, the correct classification of devices problems of customer premises devices may be important for several reasons. For example, correct classification of customer premises device problems generally improves the problem ticket resolution workflow, enables customer care teams and management levels to leverage correct statistics on customer premises device problems in order to improve the performance of the customer premises devices as well as communication networks via which the customer premises devices communicate, may be used to train prediction models for predicting customer premises device problems before the customer premises device problems actually occur, and may have various other benefits. Customer care agents typically classify customer premises device problems manually by using trouble ticket information that is entered into trouble tickets based on phone calls from customers reporting customer premises device problems. Disadvantageously, however, customer care agents may make errors in classifying customer premises device problems due to errors made while classifying the associated trouble tickets into problems types.

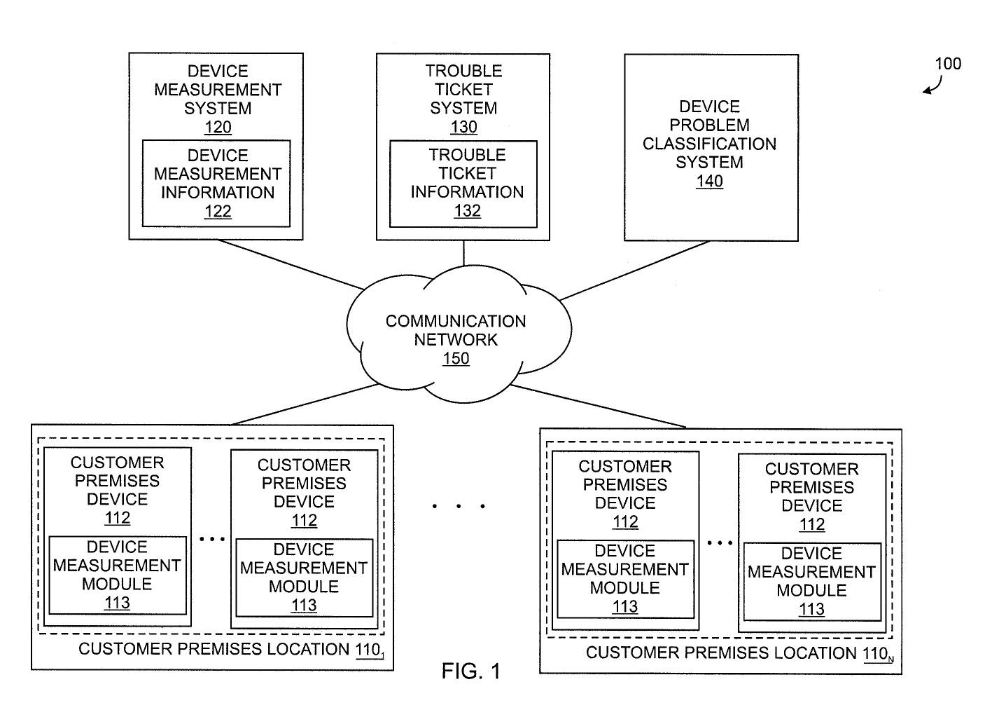

Accordingly, a capability for classifying device problems of customer premises devices is presented. In at least some embodiments, classification of a device problem of a customer premises device of a customer may be performed based on text mining of customer trouble ticket information of a trouble ticket of the customer. In at least some embodiments, classification of a device problem of a customer premises device may be performed based on text mining of customer trouble ticket information of a trouble ticket of the customer and based on customer device measurement information of the customer premises device of the customer. In at least some embodiments, classification of a device problem of a customer premises device may be performed based on text mining of customer trouble ticket information of a trouble ticket of the customer and based on customer device measurement information for the customer premises device of the customer, as well as based on historical trouble ticket information and historical device measurement information. In at least some embodiments, classification of a device problem of a customer premises device may be performed based on at least one of fusion (which also may be referred to herein as integration or mapping) of trouble ticket information and device measurement information (e.g., fusion of customer trouble ticket information and customer device measurement information, fusion of historical trouble ticket information and historical device measurement information, or the like, as well as various combinations thereof). In at least some embodiments, text mining of trouble ticket information of trouble tickets may be performed based on training of regular expressions for trouble ticket information. Various embodiments of the capability for classifying device problems of customer premises devices provide more reliable classification of device problems of customer premises devices. These and various other capabilities for classifying a device problem of a customer premises device of a customer may be better understood by way of reference to the exemplary communication system of FIG. 1.

FIG. 1 depicts an exemplary communication system including a device problem classification system that is configured to support classification of device problems of customer premises devices.

The exemplary communication system 100 includes a set of customer premises locations (CPLs) 110₁-110_{N} (collectively, CPLs 110), a device measurement system (DMS) 120, a trouble ticket system (US) 130, a device problem classification system (DPCS) 140, and a communication network (CN) 150.

The CPLs 110₁-110_{N} include sets of customer premises devices (CPDs) 112₁-112_{N} (collectively, CPDs 112), respectively. In general, a CPL 110 of a customer may be a home, a business, or the like. The set of CPDs 112 for a CPL 110 may include one or more CPDs 112, at least one of which is configured to interface with CN 150. The set of CPDs 112 for a CPL 110 may include any suitable type(s) of CPDs which may be deployed at the CPL 110. For example, a CPD 112 may be a modem, a router, a switch, residential gateway, a set-top box (STB), a gateway, or the like, as well as various combinations thereof. It will be appreciated that a given CPL 110 may include multiple CPDs 112 of the same type (e.g., multiple STBs, multiple gateways, or the like).

The DMS 120 is configured to obtain device measurement information for CPDs 112 of CPLs 110. The DMS 120 may obtain device measurement information for a given CPD 112 periodically, in response to a trigger condition (e.g., detection of a condition associated with the given CPD 112 or a related CPD 112, detection of a network condition associated with a network serving the given CPD 112, responsive to a request from another system, or the like, as well as various combinations thereof), or the like, as well as various combinations thereof. The DMS 120 may obtain device measurement information for a given CPD 112 by receiving device measurement information from the given CPD 112 where the given CPD 112 is configured to send the device measurement information to the DMS 120 (e.g., again, periodically, in response to a trigger condition, or the like), sending a request for device measurement to the given CPD 112 for causing the given CPD 112 to reply with device measurement information, or the like, as well as various combinations there. As depicted in FIG. 1, each CPD 112 may include a respective device measurement module (DMM) 113 configured to collect device measurement information at the CPD 112 and to provide collected device measurement information from the CPD 112 to the DMS 120. The device measurement information for a given CPD 112 may include any set of parameters suitable for use in evaluating a device problem associated with the given CPD 112 (e.g., performing root cause analysis of the device problem, classifying the device problem, or the like, as well as various combinations thereof). The device measurement information for a given CPD 112 may vary across different types of CPDs 112. For example, in the case of a network gateway, the device measurement information may include counts of received and sent bytes. For example, in the case of a cable modem, the device measurement information may include optical network terminal alarm flags. The types of device measurement information typically available from CPDs 112 will be understood by one skilled in the art. The device measurement information that is received at and maintained by DMS 120 for CPDs 112 of the CPLs 110 is represented in FIG. 1 as device measurement information 122. The DMS 120 may be configured to provide device measurement information 122 to one or more of TTS 130, DPCS 140, or the any other system or device which may utilize device measurement information 122.

The TTS 130 is configured to support creation and management of trouble tickets for problems or potential problems associated with CPDs 112 of CPLs 110. The TTS 130 may be configured to support creation of a trouble ticket for one or more problems or one or more potential problems associated with one or more CPDs 112 of the CPL 110 of a given customer. The TTS 130 may be configured to support creation of a trouble ticket manually (e.g., via entry of information by a customer care specialist using TTS 130 based on a conversation with the customer when the customer calls to report a problem or potential problem, via online entry of information by the customer where TTS 130 supports a customer-accessible interface), automatically (e.g., via use of voice recognition and analysis mechanisms to identify and analyze information spoken by the customer or a user of TTS 130 and to determine therefrom trouble ticket information that is then included in the trouble ticket), or using a combination of manual and automated mechanisms for creation of the trouble ticket.

The trouble ticket information of a trouble ticket created for one or more problems or potential problems associated with one or more CPDs 112 of the CPL 110 of a given customer may include any suitable information which may be necessary or desirable within the context of handling of one or more problems or potential problems associated with one or more CPDs 112 of the CPL 110 of a given customer. For example, trouble ticket information of a trouble ticket created for one or more problems or potential problems associated with one or more CPDs 112 of the CPL 110 of a given customer may include customer contact information (e.g., name, address, telephone number, email address, or the like), CPD characteristics information associated with the one or more CPDs 112 (e.g., a CPD identifier of a CPD 112, a device type of a CPD 112, a manufacturer name of a CPD 112, a version number of a CPD 112, or the like), problem code information (e.g., a code or codes indicative of the problem or potential problem as described by the customer, a code or codes indicative of the problem or potential problem as specified by a user of TTS 130, or the like), problem description information for the one or more problems or potential problems (e.g., a description of the problem or potential problem as described by the customer, a description of the problem or potential problem entered by a user of TTS 130 based on information provided by the customer), problem resolution information for the one or more problems or potential problems (e.g., a description of the resolution for the problem or potential problem), or the like, as well as various combinations thereof. For example, some examples of problem description information which may provided by the customer may include an indication that there is no phone service, an indication that there is no phone or Internet service, an indication that there is no television service, an indication that there is no dial tone, an indication that access to the Internet is running slower than expected, or the like, as well as various combinations thereof. The typical trouble ticket information of a trouble ticket created for one or more problems or potential problems associated with one or more customer premises devices of a given customer will be understood by one skilled in the art.

The trouble ticket information of a trouble ticket created for one or more problems or potential problems associated with one or more CPDs 112 of the CPL 110 of a given customer may be represented in various ways. For example, at least a portion of the trouble ticket information of a trouble ticket may be represented using one of more defined values of one or more defined fields (e.g., where the one or more defined values for a given field may be selected from a set of available values available for selection for the given field). For example, at least a portion of the trouble ticket information of a trouble ticket may be represented using one or more free-form text fields that allow free-form entry of trouble ticket information (e.g., text entered based on voice capture of one or both of the customer or a user of the TT 130 when the customer calls to report a problem or potential problem, text entered by a user of the TT 130 manually, or the like, as well as various combinations thereof). The typical manner in which trouble ticket information may be represented in a trouble ticket for a customer will be understood by one skilled in the art.

The trouble ticket information that is captured at and maintained by TTS 130 for CPDs 112 of the CPLs 110 is represented in FIG. 1 as trouble ticket information 132. The TTS 130 may be configured to provide trouble ticket information 132 to one or more of DMS 120, DPCS 140, or the any other system or device which may utilize trouble ticket information 132.

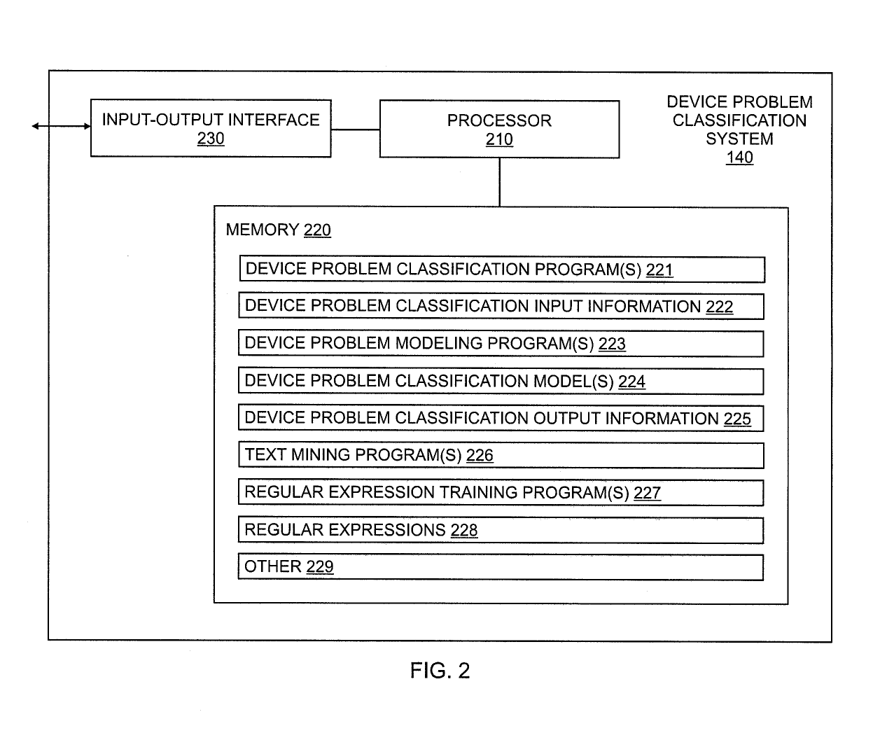

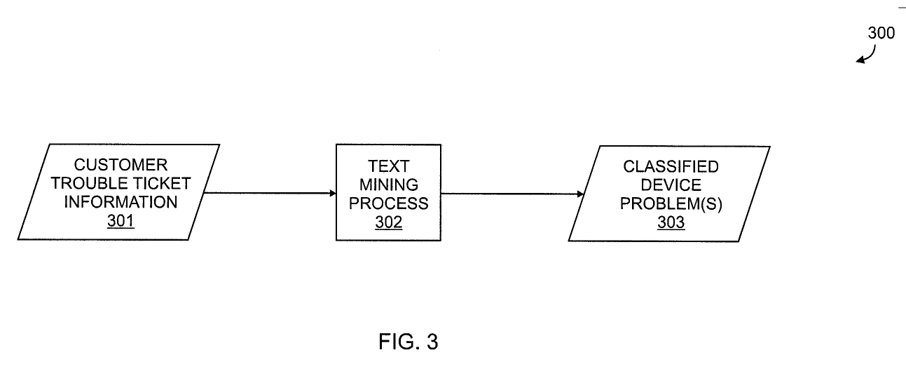

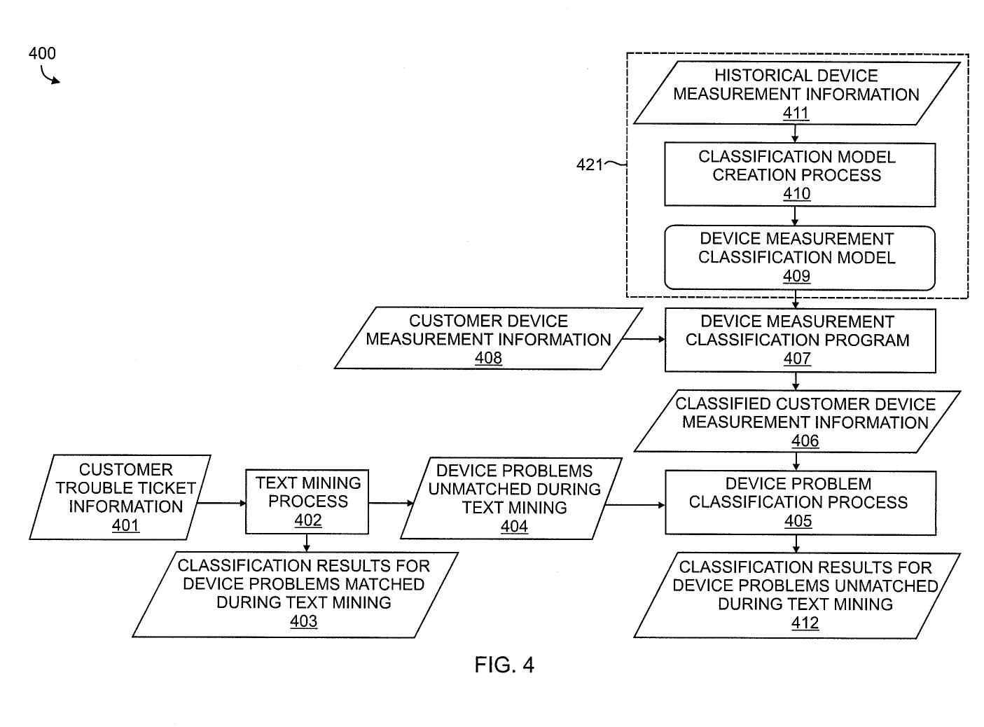

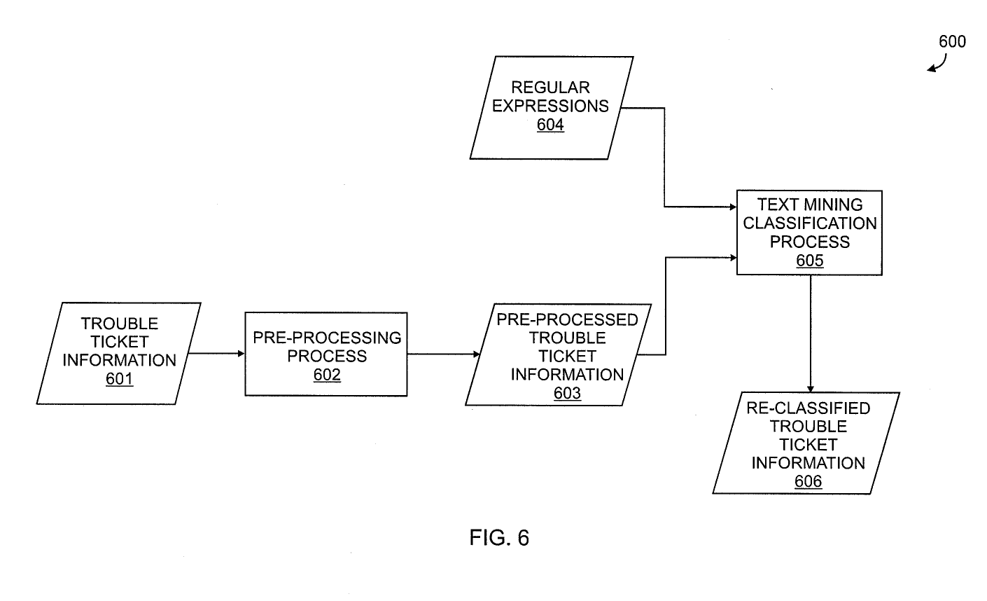

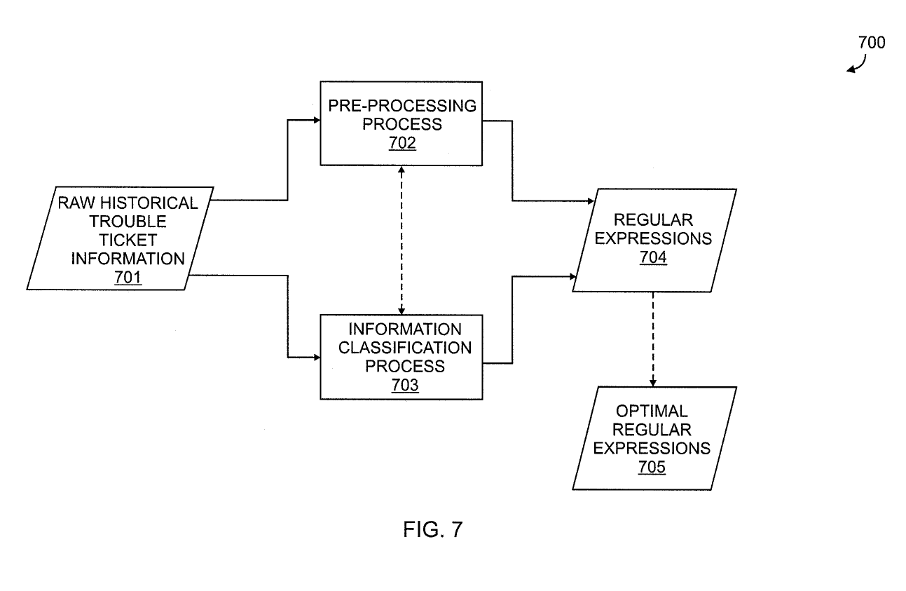

The DPCS 140 is configured to classify device problems of CPDs 112 of CPLs 110. The DPCS 140 may be configured to classify one or more device problems of one or more CPDs 112 of the CPL 110 of a given customer. The DPCS 140 may be configured to classify one or more device problems of one or more CPDs 112 of the CPL 110 of a given customer based on text mining of customer trouble ticket information of a trouble ticket created for the one or more CPDs 112 of the CPL 110 of the customer (an exemplary embodiment of which is depicted and described with respect to FIG. 3). The DPCS 140 may be configured to classify one or more device problems of one or more CPDs 112 of the CPL 110 of a given customer based on a combination of text mining of historical trouble ticket information of TTS 130 and customer device measurement information obtained from at least one of the one or more CPDs 112 of the CPL 110 of the customer (an exemplary embodiment of which is depicted and described with respect to FIG. 4). The DPCS 140 may be configured to classify one or more device problems of one or more CPDs 112 of the CPL 110 of a given customer based on a combination of text mining of trouble ticket information (including customer trouble ticket information of a trouble ticket created for the one or more CPDs 112 of the CPL 110 of the customer and historical trouble ticket information of TTS 130) and device measurement information (including customer device measurement information obtained from at least one of the one or more CPDs 112 of the CPL 110 of the customer and historical device measurement information) (an exemplary embodiment of which is depicted and described with respect to FIG. 4). The DPCS 140 may be configured to perform text mining of trouble ticket information based on training of regular expressions from historical trouble ticket information 132 maintained by TT 130 (an exemplary embodiment of which is depicted and described with respect to FIG. 6). The DPCS 140 may be configured to determine or train regular expressions from trouble ticket information 132 maintained by TT 130 based on text cleaning and classification functions executed on trouble ticket information 132 maintained by TT 130 (an exemplary embodiment of which is depicted and described with respect to FIG. 7). The DPCS 140 may be configured to perform various other functions related to classification of device problems of CPDs 112 of CPLs 110. The DPCS 140 may be implemented in any suitable manner, an exemplary embodiment of which is depicted and described with respect to FIG. 2.

The CN 150 may include type of communication network(s) suitable for support communications of CPDs of CPLs 110. For example, CN 150 may include one or more wireline access networks (e.g., a cable network, Digital Subscriber Line (DSL) network, or the like), one or more wireless access networks (e.g., a Wireless Fidelity (WiFi)-based access network, a cellular access network, or the like), one or more wireline core networks, one or more wireless core networks, one or more public data networks, one or more private data networks, or the like, as well as various combinations thereof. The CN 150 also may include type of communication network(s) suitable for support communications DMS 120, TTS 130, and DPCS 140 (e.g., one or more wireline core networks, one or more wireless core networks, one or more public data networks, one or more private data networks, or the like, as well as various combinations thereof).

It will be appreciated that, although primarily depicted and described with respect to embodiments in which functions related to obtaining device measurement information, functions associated with creation and handling of trouble tickets, and functions associated with classification of device problems are distributed across the DMS 120, TTS 130, and DPCS 140, respectively, these functions may be distributed or combined in various other ways using fewer or more systems, elements, or the like.

FIG. 2 depicts an exemplary implementation of the device problem classification system of FIG. 1. As depicted in FIG. 2, DPCS 140 includes a processor 210, a memory 220, and an input-output interface 230. The processor 210 is communicatively connected to memory 220 and input-output interface 230. The processor 210 is configured to provide various functions of the device problem classification capability. The input-output interface 230 is configured to interface with CN 150 of FIG. 1. The memory 220 is configured to store various programs and data for use by the processor 210 in providing various functions of the device problem classification capability. The memory 220 includes one or more device problem classification programs (DPCPs) 221, device problem classification input information (DPCII) 222, one or more device problem modeling programs (DPMPs) 223, one or more device problem classification models (DPCMs) 224, device problem classification output information (DPCOI) 225, one or more text mining programs (TMPs) 226, one or more regular expression training programs (RETPs) 227, regular expressions (REs) 228, and so forth (represented by Other 229 in FIG. 2).

The one or more DPCPs 221 may be configured to classify one or more device problems of one or more CPDs 112 of the CPL 110 of a given customer based on DPCII 222 to produce thereby DCPOI 225. The DPCII 222 may include any information which may be used by the one or more DPCPs 221 (or any other associated programs, such as DPMPs 223, TMPs 226, or the like) to classify one or more device problems of one or more CPDs 112 of the CPL 110 of a given customer (e.g., trouble ticket information 132 of TT 130 which may be processed by DPMPs 223 to generate DCPMs 224, trouble ticket information for a trouble ticket corresponding to the one or more device problems to be classified, device measurement information 122 of DMS 120 which may be processed by DPMPs 223 to generate DCPMs 224, device measurement information for one or more CPDs 112 associated with a trouble ticket corresponding to the one or more device problems to be classified, or the like, as well as various combinations thereof). The DPMPs 223 may include one or more device problem modeling programs configured to generate the one or more DPCMs 223 based on modeling input information (e.g., trouble ticket information 132 of TT 130, device measurement information 122 of DMS 120, or the like, as well as various combinations thereof). The DPCMs 224 may include one or more classification models, generated by DPMPs 223, which may be used by DPCPs 221 to classify one or more device problems of one or more CPDs 112 of the CPL 110 of a given customer. The DPCOI 225 includes information resulting from execution of DPCPs 221 (e.g., for a trouble ticket corresponding to the one or more device problems to be classified, classification of the one or more device problems of the trouble ticket). The TMPs 226 may include one or more text mining programs configured to be used in conjunction with DPCPs 221 to classify one or more device problems of one or more CPDs 112 of the CPL 110 of a given customer (e.g., a DPCPs 221 may call a TMP 226 to perform text mining on trouble ticket information for a trouble ticket corresponding to the one or more device problems to be classified). The TMPs 226 may include one or more text mining programs configured to be used in conjunction with DPMPs 223 to generate DCPMs 224 (e.g., a DPMPs 223 may call a TMP 226 to perform text mining on trouble ticket information 132 of TT 130 for use in generating one of the DPCMs 224). The TMPs 226 may utilize REs 228 where use of text mining for classification of device problems is based on REs 228. The RETPs 227 may include one or more programs configured to train REs 228. It will be appreciated that the various programs and data of memory 220 may be organized in various other ways. It will be appreciated that memory 220 may include less or more programs or data for use by processor 210 in providing functions of the device problem classification capability. FIG. 3 depicts an embodiment of a method for performing device problem classification for one or more customer premises devices of a customer based on text mining of customer trouble ticket information of a trouble ticket for the customer. In method 300 of FIG. 3, customer trouble ticket information 301 is processed by a text mining process 302 to produce classified device problems 303. The customer trouble ticket information 301 is specific to the customer, and includes information from a trouble ticket of the customer. The trouble ticket information 301 may include information describing one or more device problems of one or more CPDs of a CPL of the customer. The text mining process 302 is configured to process the customer trouble ticket information 301 to determine the classified device problems 303. The text mining process 302 may be configured to process the description of a device problem as represented in customer trouble ticket information 301 to determine therefrom a corresponding device problem classification for the device problem. The text mining process 302 may be configured to process the description of a device problem based on a set of regular expressions determined from historical trouble ticket information of a trouble ticket system, which will be understood to be a larger set of trouble ticket information than the customer trouble ticket information 301 of the trouble ticket currently being processed. The text mining process 302 may be configured to process the description of a device problem based on a set of regular expressions by searching the set of regular expressions to identify a match between the description of the device problem (e.g., from the device problem narrative in the corresponding trouble ticket) and one of the regular expression (or multiple matches to multiple regular expressions). In one embodiment, text mining process 302 may be implemented as depicted and described with respect to FIG. 6. The classified device problems 303 may include, for each device problem of customer trouble ticket information 301 matched by text mining process 302, an indication of the device problem classification (or classifications, where the device problem may have multiple device problem classifications associated therewith) for the device problem. For example, within the context of FIG. 2, the method 300 may be one of the DPCPs 221, customer trouble ticket information 301 may be part of DPCII 222, text mining process 302 may be one of the TMPs 226, and classified device problems 303 may be part of DPCOI 225.

FIG. 4 depicts an embodiment of a method for performing device problem classification for one or more customer premises devices of a customer based on text mining of customer trouble ticket information of a trouble ticket for the customer and classification of customer device measurement information from one or more customer premises devices of the customer. It will be appreciated that, although primarily depicted and described herein as being performed in a particular order, at least a portion of method 400 of FIG. 4 may be performed in a different order than depicted in FIG. 4.

In method 400 of FIG. 4, customer trouble ticket information 401 is processed by a text mining process 402 in order to attempt to classify each of the device problems included in customer trouble ticket information 401. The customer trouble ticket information 401 is specific to the customer, and includes information from a trouble ticket of the customer. The trouble ticket information 401 may include information describing one or more device problems of one or more CPDs of a CPL of the customer. The text mining process 402 is configured to process the customer trouble ticket information 401 in order to attempt to classify each of the device problems included in customer trouble ticket information 401. The text mining process 402 may be configured to process the description of a device problem as represented in customer trouble ticket information 401 to determine thereby a corresponding device problem classification for the device problem. The text mining process 402 may be configured to process the description of a device problem based on a set of regular expressions determined from historical trouble ticket information of a trouble ticket system, which will be understood to be a larger set of trouble ticket information than the customer trouble ticket information 401 of the trouble ticket currently being processed for device problem classification. The text mining process 402 may be configured to process the description of a device problem based on a set of regular expressions by searching the set of regular expressions to identify a match between the description of the device problem (e.g., from the device problem narrative in the corresponding trouble ticket) and one of the regular expressions (or multiple matches to multiple regular expressions). In one embodiment, text mining process 402 may be implemented as depicted and described with respect to FIG. 6. As depicted in FIG. 4, there may be one or more device problems of customer trouble ticket information 401 that can be classified by text mining process 402, thereby resulting in classification results for device problems matched during text mining 403. The classification results for device problems matched during text mining 403 may include, for each device problem of customer trouble ticket information 401 matched by text mining process 402, an indication of the device problem classification for the device problem. It will be appreciated that, where text mining process 402 is unable to classify any of the device problems of customer trouble ticket information 401, the classification results for device problems matched during text mining 403 may be empty. As further depicted in FIG. 4, however, there may be one or more device problems of customer trouble ticket information 401 that cannot be classified by text mining process 402, thereby resulting in a set of device problems unmatched during text mining 404. The set of device problems unmatched during text mining 404 may be represented in any suitable manner (e.g., as a modified version of customer trouble ticket information 401, as a combination of portions of customer trouble ticket information 401 corresponding to the one or more device problems unmatched during text mining 404, or the like). It will be appreciated that, where text mining process 402 is unable to classify any of the device problems of customer trouble ticket information 401, the set of device problems matched during text mining 403 may be empty. It also will be appreciated that, where text mining process 402 is able to classify all of the device problems of customer trouble ticket information 401, the set of device problems unmatched during text mining 404 may be empty (although here it is assumed that this is not the case, so that the operation of the remaining parts of method 400 of FIG. 4 may be described). Accordingly, in method 400 of FIG. 4, the set of device problems unmatched during text mining 404 is processed by a device problem classification process 405 in order to attempt to classify each of the device problems included in the set of device problems unmatched during text mining 404. The processing of the set of device problems unmatched during text mining 404 by device problem classification process 405 based on classified customer device measurement information 406 produces classification results for device problems unmatched during text mining 412.

In method 400 of FIG. 4, as indicated above, the device problem classification process 405 processes the set of device problems unmatched during text mining 404 in order to attempt to classify each of the device problems included in the set of device problems unmatched during text mining 404. The device problem classification process 405 processes the set of device problems unmatched during text mining 404 based on classified customer device measurement information 406 associated with one or more CPDs of the customer. The classified customer device measurement information 406 associated with one or more CPDs of the customer may include measurements of the traffic for one or more CPDs of the customer for which a device problem type(s) has been determined, device status of one or more CPDs of the customer for which a device problem type(s) has been determined, or the like, as well as various combinations thereof. The classified customer device measurement information 406 may include modification of the customer device measurement information 408 to include mappings of one or more device problem types to one or more portions of the customer device measurement information. The classified customer device measurement information 406 associated with one or more CPDs of the customer may be generated by a device measurement classification process 407.

In method 400 of FIG. 4, as indicated above, device measurement classification process 407 generates classified customer device measurement information 406 for use by device problem classification process 405 in processing the set of device problems unmatched during text mining 404 in order to attempt to classify each of the device problems included in the set of device problems unmatched during text mining 404. The device measurement classification process 407 generates classified customer device measurement information 406 based on customer device measurement information 408 and a device measurement classification model 409. The customer device measurement information 408 includes the device measurements for one or more CPDs of the customer, which may include all of the CPDs of the CPL of the customer (e.g., even for one or more CPDs not associated with device problems unmatched during text mining 404), a subset of the CPDs of the CPL of the customer (e.g., only for one or more CPDs associated with device problems unmatched during text mining 404), and the like, as well as various combinations thereof. The customer device measurement information 408 may include device measurements for one or more CPDs of the customer where the device measurements correspond to the customer trouble ticket information 401 (e.g., device measurements that are contemporaneous with reporting or creation of the trouble ticket for the customer, device measurements that are made before or after reporting or creation of the trouble ticket for the customer and are considered to be associated with reporting or creation of the trouble ticket for the customer, or the like, as well as various combinations thereof). The device measurement classification model 409 may include a set of reference mappings of sets of historical device measurement information to device problem types known to be associated with those sets of historical device measurement information, respectively. The device measurement classification process 407 processes customer device measurement information 408, based on device measurement classification model 409, in order to classify customer device measurement information 408 and, thus, to form thereby classified customer device measurement information 406. The device measurement classification process 407 customer device measurement information 408 based on device measurement classification model 409 to form classified customer device measurement information 406 by (1) determining a match between customer device measurement information 408 (or a portion of customer device measurement information 408) and device measurement classification model 409 (e.g., a reference mapping of device measurement classification model 409) and (2) modifying the customer device measurement information 408 to include the device problem type associated with the matching portion of the device measurement classification model 409 (e.g., a reference mapping) to form thereby the classified customer device measurement information 406. In other words, as noted above, classified customer device measurement information 406 may include mappings of one or more device problem types to one or more portions of the customer device measurement information from the customer device measurement information 408. The device measurement classification model 409 may be generated by a classification model creation process 410.

In method 400 of FIG. 4, as indicated above, classification model creation process 410 generates device measurement classification model 409 for use by device measurement classification process 407 in generating the classified customer device measurement information 406. The classification model creation process 410 generates the device measurement classification model 409 based on historical device measurement information 411. The historical device measurement information 411 may include historical device measurement information at any suitable granularity (e.g., past device measurements from CPDs of the customer, past device measurements from CPDs of customers associated with the same access network as the customer, past device measurements from CPDs of customers of the service provider, or the like, as well as various combinations thereof), but is expected to be a larger set of device measurement information than the customer device measurement information 408 associated with the trouble ticket currently being processed for device problem classification. The classification model creation process 410 may generate the device measurement classification model 409 based on historical device measurement information 411 by, for historical device measurement information 411 or for one or more portions of the historical device measurement information 411, identifying a device problem type known to be associated with the historical device measurement information 411 or with the portion of the historical device measurement information 411 and associating the device problem type with the historical device measurement information 411 or the associated portion of the historical device measurement information 411. In other words, the device measurement classification model 409 may include a set of one or more reference mappings of historical device measurement information to a device problem type associated with the historical device measurement information.

In method 400 of FIG. 4, as indicated above, the device problem classification process 405 processes the set of device problems unmatched during text mining 404, based on classified customer device measurement information 406, to produce thereby the classification results for device problems unmatched during text mining 412. The classification results for device problems unmatched during text mining 412 may include, for each device problem of customer trouble ticket information 401 that was not matched by text mining process 402, an indication of the device problem classification for the device problem that was determined based on classification of the customer device measurement information 408 by device measurement classification process 407 based on historical device measurement information 411 represented in the form of device measurement classification model 409.

It will be appreciated that the combination of classification results for device problems matched during text mining 403 and classification results for device problems unmatched during text mining 412 provides the full set of classified device problems for the one or more device problems of the one or more CPDs of the CPL of the customer (e.g., one or more device problem classifications identified for each of the one or more device problems of the one or more CPDs of the CPL of the customer, respectively).

It will be appreciated that, although primarily depicted and described herein as being performed in a particular order, at least a portion of method 400 of FIG. 4 may be performed in a different order than depicted in FIG. 4. For example, although primarily depicted and described with respect to an embodiment in which customer trouble ticket information 401 is processed by text mining process 402 to identify device problems unmatched during text mining 404 and then customer device measurement information 408 is used as a basis for classifying device problems unmatched during text mining, it will be appreciated that, in at least some embodiments, text mining of customer trouble ticket information 401 and processing of customer device measurement information 408 may be used contemporaneously to classify device problems, may be used in combination may be used in combination to classify device problems, may be used in a different order (e.g., attempting to classify customer device problems based on customer device measurement information 408 and then further refining classification of customer device problems based on processing of customer trouble ticket information 401 by text mining process 402) to classify device problems, or the like.

It will be appreciated that, although depicted and described in FIG. 4 as being a single, combined process, in at least some embodiments one or more portions of method 400 of FIG. 4 may be implemented as one or more separate processes that may be used in various ways (e.g., executed at different times, configured to include specific calls to invoke different processes, or the like) to provide the various functions depicted and described with respect to FIG. 4. In at least some embodiments, for example, classification model creation process 410 may be provided as a standalone process that may be executed, at any time prior to or even contemporaneous with execution of other portions of method 400, to create the device measurement classification model 409 based on the historical device measurement information 411 (as illustrated by the dotted-line box 421 around elements 409-411 of FIG. 4). In at least some embodiments, for example, text-mining process 402 may be implemented as a standalone process that generates device problems unmatched during text mining 404 based on customer trouble ticket information 401 (illustratively, elements 401-404), classification model creation process 410 may be implemented as a standalone process that generates device measurement classification model 409 based on historical device measurement information 411 (illustratively, elements 409-411), device measurement classification program 407 may be implemented as a standalone process that generates customer device measurement information 406 based on customer device measurement information 408 and device measurement classification model 409 (illustratively, elements 406-409), and device problem classification process 405 may be implemented as a standalone process that generates classification results for device problems unmatched during text mining 412 based on device problems unmatched during text mining 404 and classified customer device measurement information 406 (illustratively, elements 404-406 and 412). Various other implementations of the functions of method 400 of FIG. 4 are contemplated.

The method 400 of FIG. 4 may be better understood by considering an exemplary implementation of method 400 within the context of FIG. 2. For example, within the context of FIG. 2, the method 400 may be one of the DPCPs 221, customer trouble ticket information 401 and customer device measurement information 408 may be part of DPCII 222, text mining process 402 may be one of the TMPs 226, device measurement classification model 409 may be one of the DPCMs 224, classification model creation process 410 may be one of the DPMPs 223, and classification results for device problems matched during text mining 403 and classification results for device problems unmatched during text mining 409 may be part of DPCOI 225.

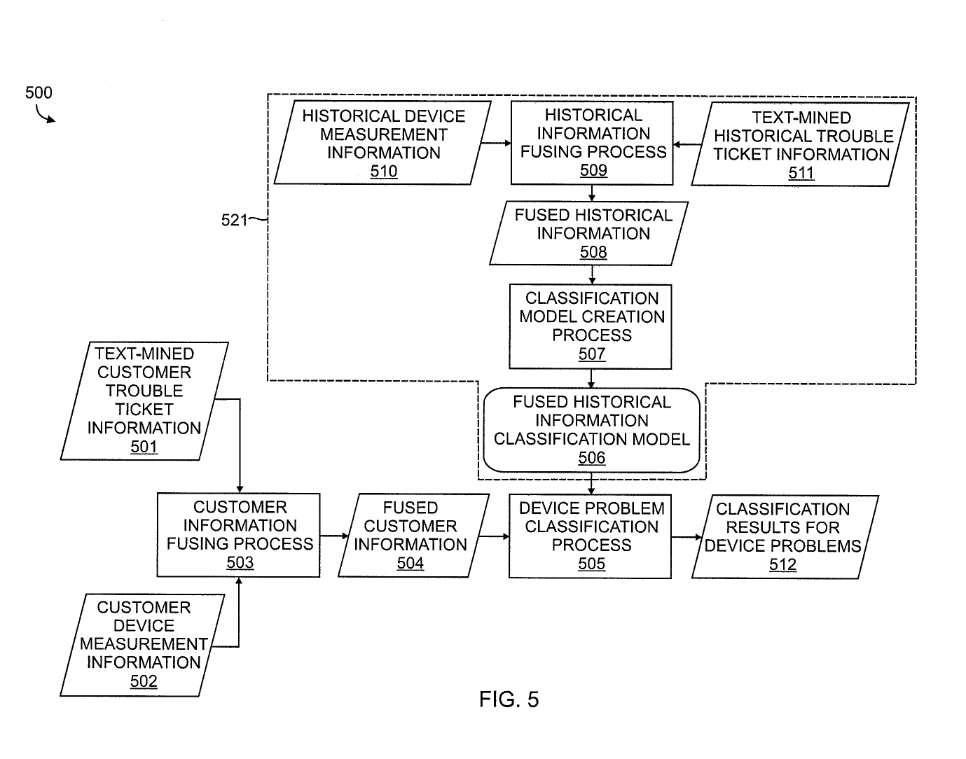

FIG. 5 depicts an embodiment of a method for performing device problem classification for one or more customer premises devices of a customer based on fusion of trouble ticket information and device measurement information. It will be appreciated that, although primarily depicted and described herein as being performed in a particular order, at least a portion of method 500 of FIG. 5 may be performed in a different order than depicted in FIG. 5.

In method 500 of FIG. 5, a device problem classification process 505 classifies device problems for one or more CPDs of a CPL of a customer based on fused customer information 504 and a fused historical information classification model 506. The device problem classification process 505 processes the fused customer information 505, based on a fused historical information classification model 506, to determine classification results for device problems 512. The fused customer information 505 is generated by a customer information fusing process 503. The fused historical information classification model 506 is generated by a classification model creation process 507.

In method 500 of FIG. 5, as indicated above, customer information fusing process 503 generates the fused customer information 505 that is used by device problem classification process 505 to determine the classification results for device problems 512. The customer information fusing process 503 generates the fused customer information 505 based on text-mined customer trouble ticket information 501 and customer device measurement information 502.

The text-mined customer trouble ticket information 501 is specific to the customer. The text-mined customer trouble ticket information 501 is generated by a text mining process configured to perform text-mining of customer trouble ticket information from a trouble ticket of the customer. The text-mined customer trouble ticket information 501 includes a set of mappings of regular expressions to device problem narratives from the customer trouble ticket information of the trouble ticket of the customer. The text-mined customer trouble ticket information 501 may be represented as a vector indicating matches of regular expressions to device problem narratives. The text mining process that is used to generate text-mined customer trouble ticket information 501 may generate the text-mined customer trouble ticket information 501 by searching the customer trouble ticket information of the trouble ticket of the customer using a set of regular expressions in order to identify regular expressions within device problem narratives included within the customer trouble ticket information of the trouble ticket of the customer. In one embodiment, the text mining process that is used to generate text-mined customer trouble ticket information 501 may be implemented as depicted and described with respect to FIG. 6.

The customer device measurement information 502 is specific to the customer, and includes one or more device measurements for one or more CPDs of the customer, which may include all of the CPDs of the CPL of the customer, a subset of the CPDs of the CPL of the customer, and the like, as well as various combinations thereof. The customer device measurement information 502 may include device measurements for one or more CPDs of the customer where the device measurements correspond to the text-mined customer trouble ticket information 501 (e.g., device measurements that are contemporaneous with reporting or creation of the trouble ticket for the customer, device measurements that are made before or after reporting or creation of the trouble ticket for the customer and are considered to be associated with reporting or creation of the trouble ticket for the customer, or the like, as well as various combinations thereof).

The fused customer information 504 includes, for each of one or more CPDs of the customer, a combination of a set of device measurements for the CPD and an indication of one or more matches of one or more regular expressions with the device problem narrative in the corresponding trouble ticket for the CPD. For example, the fused customer information 504 may include, for each of one or more CPDs of the customer, a vector including a set of device measurements for the CPD that is augmented to include a binary vector indicative of one or more matches of one or more regular expressions with the device problem narrative in the corresponding trouble ticket for the CPD. The customer information fusing process 503 is configured to process the text-mined customer trouble ticket information 501 and the customer device measurement information 502 to form the fused customer information 504 by, for each of one or more CPDs of the customer, combining a set of device measurements for the CPD and an indication of one or more matches of one or more regular expressions with the device problem narrative in the corresponding trouble ticket for the CPD (e.g., augmenting a vector including a set of device measurements for the CPD with a binary vector indicative of one or more matches of one or more regular expressions with the device problem narrative in the corresponding trouble ticket for the CPD).

In method 500 of FIG. 5, as indicated above, classification model creation process 507 generates the fused historical information classification model 506 that is used by device problem classification process 505 to determine the classification results for device problems 512. The classification model creation process 507 generates the fused historical information classification model 506 based on fused historical information 508. The fused historical information 508 includes a fusing of historical device measurement information 510 and text-mined historical trouble ticket information 511. The fused historical information 508 is generated by a historical information fusing process 509. The fused historical information 508 includes a set of mappings of device measurements for a CPD or CPD type to one or more regular expressions matching device problem narratives in corresponding trouble tickets for the CPD or CPD type when the CPD or CPD type experiences those associated device measurements. For example, a set of device measurements for a particular CPD type may be mapped to a set of regular expressions matching device problem narratives in corresponding trouble tickets for that CPD type when that CPD type experiences measurements the same as or similar to the set of device measurements. This results in a combination of a set of device measurements and a set of regular expressions matching device problem narratives in corresponding trouble tickets that may be mapped to a particular device problem type for the associated CPD or CPD type. It will be appreciated that, for a given CPD or CPD type, a given set of device measurements may be mapped to multiple sets of regular expressions matching device problem narratives in corresponding trouble tickets for the CPD or CPD type when the CPD or CPD type experiences the given set of device measurements (which may result in mappings to multiple device problem types), a given set of regular expressions matching device problem narratives in corresponding trouble tickets for the CPD or CPD type may be mapped to multiple sets of device measurements (again, which may result in mappings to multiple device problem types), multiple sets of device measurements may be mapped to multiple sets of regular expressions matching device problem narratives in corresponding trouble tickets for the CPD or CPD type when the CPD or CPD type experiences the given set of device measurements (again, which may result in mappings to multiple device problem types), or the like, as well as various combinations thereof. The fusing of historical device measurement information 510 and text-mined historical trouble ticket information 511 in this manner enables classification model creation process 507 to map known device problem types to known mappings of device measurements for CPDs or CPD types to regular expressions matching device problem narratives in corresponding trouble tickets for the CPDs or CPD types when the CPD or CPD types experience those associated device measurements, as discussed in addition detail below. The classification model creation process 507 is configured to generate the fused historical information classification model 506, based on fused historical information 508, by augmenting fused historical information 508 to include known device problem type information. The classification model creation process 507 may be configured to generate the fused historical information classification model 506 based on fused historical information 508 by, for each mapping of the fused historical information 508 (namely, each mapping of a set of device measurements for a particular CPD or CPD type to a set of regular expressions matching device problem narratives in corresponding trouble tickets for that CPD or CPD type when that CPD or CPD type experiences measurements the same as or similar to the set of device measurements), identifying a known device problem type that is known to be associated with that mapping (again, with that combination of device measurements and matching regular expressions) and associating the known device problem type with the mapping. Accordingly, the fused historical information classification model 506 includes a set of mappings where each mapping includes a combination of (1) a set of device measurements for a CPD or CPD type, (2) an indication of one or more matches of one or more regular expressions with device problem narratives in corresponding trouble tickets for the CPD or CPD type (e.g., in the form of a binary vector indicating matches of one or more regular expressions with device problem narratives in corresponding trouble tickets for the CPD or CPD type), and (3) an indication of a true device problem type associated with that combination of device measurements and matching regular expressions. It will be appreciated that, since each CPD or CPD type may have one or more device problem types associated therewith, fused historical information classification model 506 may include the above-described combination of information for each combination of CPD or CPD type and the one or more device problem types which may be experienced by that CPD or CPD device type. For example, where a particular CPD type (e.g., a modem) has two potential device problem types associated therewith (namely, PROB1 and PROB2), fused historical information classification model 506 may include, (1) a first mapping of a set of device measurements for the modem to one or more regular expressions with device problem narratives in corresponding trouble tickets for the modem and, further, to the known device problem type of PROB1, thereby indicating that any modem having similar device measurements and a similar set of matching regular expressions in the device problem narrative of a corresponding trouble ticket is to be classified as having a device problem type of PROB1 and (2) a second mapping of a set of device measurements for the modem to one or more regular expressions with device problem narratives in corresponding trouble tickets for the modem and, further, to the known device problem type of PROB2, thereby indicating that any modem having similar device measurements and a similar set of matching regular expressions in the device problem narrative of a corresponding trouble ticket is to be classified as having a device problem type of PROB2. It will be appreciated that the foregoing example is merely one example for a specific CPD type and specific number of potential device problem types and, thus, that fused historical information classification model 506 may include any suitable number of mappings for various combinations of CPDs or CPD types and potential device problem types for CPDs or CPD types.

In method 500 of FIG. 5, as indicated above, historical information fusing process 509 generates the fused historical information 508 that is used by classification model creation process 507 to generate the fused historical information classification model 506. The historical information fusing process 509 generates the fused historical information 508 based on the historical device measurement information 510 and text-mined historical trouble ticket information 511.

The historical device measurement information 510 may include historical device measurement information at any suitable granularity (e.g., past device measurements from CPDs of the customer, past device measurements from CPDs of customers associated with the same access network as the customer, past device measurements from CPDs of customers of the service provider, or the like, as well as various combinations thereof), but is expected to be a larger set of device measurement information than the customer device measurement information 502 associated with the trouble ticket currently being processed for device problem classification. The historical device measurement information 510 may include device measurements for CPDs of customers where the device measurements correspond to the historical trouble ticket information processed to generate text-mined historical trouble ticket information 511. The historical device measurement information 510 may be represented as a vector of device measurements.

The text-mined historical trouble ticket information 511 is generated based on historical trouble ticket information. The text-mined historical trouble ticket information 511 is generated by a text mining process configured to perform text-mining of historical trouble ticket information. The historical trouble ticket information may include historical trouble ticket information at any suitable granularity (e.g., from past trouble tickets of the customer, from past trouble tickets of similar customers, from past trouble tickets of customers associated with the same access network as the customer, from past trouble tickets of customers of the service provider, or the like, as well as various combinations thereof), but is expected to be a larger set of trouble ticket information than the text-mined customer trouble ticket information 501 associated with the trouble ticket currently being processed. The historical trouble ticket information may include historical trouble ticket information associated with the historical device measurement information 510, such that device measurements of the historical device measurement information 510 may be correlated to known device problem types from text of trouble ticket information in the historical trouble ticket information. The text-mined historical trouble ticket information 511 may include text-mined historical trouble ticket information associated with the historical device measurement information 510, such that device measurements of the historical device measurement information 510 may be correlated to known device problem types from text of trouble ticket information in the text-mined historical trouble ticket information 511. The text-mined historical trouble ticket information 511 includes a set of mappings of regular expressions to device problem narratives in trouble tickets of the historical trouble ticket information. The text-mined historical trouble ticket information 511 may be represented as a vector indicating matches of regular expressions to device problem narratives. The text mining process that is used to generate text-mined historical trouble ticket information 511 may generate the text-mined historical trouble ticket information 511 by searching the historical trouble ticket information using a set of regular expressions in order to identify regular expressions within device problem narratives included within the historical trouble ticket information (e.g., within device problem narratives of a set of trouble tickets included within the historical trouble ticket information). In one embodiment, the text mining process that is used to generate text-mined historical trouble ticket information 511 may be implemented as depicted and described with respect to FIG. 6.

The historical information fusing process 509 may generate the fused historical information 508 by combining the historical device measurement information 510 and the text-mined historical trouble ticket information 511, such that each mapping of regular expressions to device problem narratives in corresponding trouble tickets has associated therewith device measurements obtained in conjunction with the corresponding trouble tickets including that mapping of regular expressions to device problem narratives. The historical information fusing process 509 may generate the fused historical information 508 by augmenting the vector including the text-mined historical trouble ticket information 511 to include the device measurement vector of historical device measurement information 510. Accordingly, as noted above, the fused historical information 508 may include a set of mappings of device measurements for a CPD or CPD type to one or more regular expressions matching device problem narratives in corresponding trouble tickets for the CPD or CPD type when the CPD or CPD type experiences those associated device measurements.

In method 500 of FIG. 5, as indicated above, the device problem classification process 505 classifies device problems for one or more CPDs of the customer, based on the fused customer information 504 and the fused historical information classification model 506, to form thereby classification results for device problems 512. The device problem classification process 505 is configured to process the fused customer information 504 based on the fused historical information classification model 506 to produce the classification results for device problems 512 by searching the fused historical information classification model 506 using the fused customer information 504 to identify portions of the fused customer information 504 matching portions of the fused historical information classification model 506, determining device problem types associated with portions of the fused historical information classification model 506 identified as matching portions of the fused customer information 504, and associating the identified device problem types within the matching portions of the fused customer information 504, respectively. For example, where the fused customer information 504 for a particular CPD of a customer includes a particular mapping of a set of device measurements for the CPD to a set of regular expressions matching the trouble ticket narrative of the trouble ticket for the customer, the device problem type for the CPD of the customer may be determined by identifying a mapping of the fused historical information classification model 506 that is similar to the particular mapping of the fused customer information 504 (e.g., a mapping of a similar set of device measurements to a similar set of matching regular expressions) and then reading the device problem type from the identified mapping of the fused historical information classification model 506 (e.g., the associated device problem type for the particular CPD of the customer is indicated within the identified mapping of the fused historical information classification model 506). The classification results for device problems 512 may include, for each device problem of text-mined customer trouble ticket information 501, an indication of the device problem classification for the device problem (e.g., the device problem type as determined based on the fused historical information classification model 506).

It will be appreciated that, although depicted and described in FIG. 5 as being a single, combined process, in at least some embodiments one or more portions of method 500 of FIG. 5 may be implemented as one or more separate processes that may be used in various ways (e.g., executed at different times, configured to include specific calls to invoke different processes, or the like) to provide the various functions depicted and described with respect to FIG. 5. In at least some embodiments, for example, classification model creation process 507 may be provided as a standalone process that may be executed, at any time prior to or even contemporaneous with execution of other portions of method 500, to create the fused historical information classification model 506 based on the historical device measurement information 510 and the historical trouble ticket information (as illustrated by the dotted-line box 521 around elements 506-511 of FIG. 5). In at least some embodiments, for example, historical information fusing process 509 may be implemented as a standalone process that generates fused historical information 508 based on historical device measurement information 510 and text-mined historical trouble ticket information 511 (illustratively, elements 508-511), classification model creation process 507 may be implemented as a standalone process that generates fused historical information classification model 506 based on fused historical information (illustratively, elements 506-508), customer information fusing process 503 may be implemented as a standalone process that generates fused customer information 504 based on text-mined customer trouble ticket information 501 and customer device measurement information 502 (illustratively, elements 501-504), and device problem classification process 505 may be implemented as a standalone process that generates classification results for device problems 512 based on fused customer information 504 and fused historical information classification model 506 (illustratively, elements 504-506 and 512). Various other implementations of the functions of method 500 of FIG. 5 are contemplated.

The method 500 of FIG. 5 may be better understood by considering an exemplary implementation of method 500 within the context of FIG. 2. For example, within the context of FIG. 2, method 500 or portions of method 500 may be one of the DPCPs 221, text-mined customer trouble ticket information 501 and customer device measurement information 502 may be part of DPCII 222, fused historical information classification model 506 may be one of the DPCMs 224, classification model creation process 507 may be one of the DPMPs 223, text mining processes used to generate text-mined trouble ticket information may be one of the TMPs 226, historical device measurement information 510 and text-mined historical trouble ticket information 511 may be part of DPCII 222, and classification results for device problems 512 may be part of DPCOI 225.

FIG. 6 depicts an embodiment of a method for performing text mining of trouble ticket information based on training of regular expressions from historical trouble ticket information. It will be appreciated that, although primarily depicted and described herein as being performed in a particular order, at least a portion of method 600 of FIG. 6 may be performed in a different order than depicted in FIG. 6. As noted above, method 600 of FIG. 6 may be used as text mining process 302 of FIG. 3, as text mining process 402 of FIG. 4, for text mining within the context of FIG. 5, or the like. The method 600 of FIG. 6 may be used for text mining of trouble ticket information within various other contexts.

In method 600 of FIG. 6, a text mining classification process 605 performs text mining on trouble ticket information (illustratively, pre-processed trouble ticket information 603) using regular expressions 604 to produce re-classified trouble ticket information 606. The pre-processed trouble ticket information 603 is produced by a pre-processing process 602 configured to perform pre-processing of trouble ticket information 601. The trouble ticket information 601 and, thus, the pre-processed trouble ticket information 603, may include customer trouble ticket information or historical trouble ticket information, depending on the context within which method 600 is used. For example, where method 600 is used as text mining process 302 of FIG. 3 or text mining process 402 of FIG. 4, trouble ticket information 601 and pre-processed trouble ticket information 603 are customer trouble ticket information associated with a particular customer for which a trouble ticket is being processed for device problem classification. For example, where method 600 is used for text mining within the context of FIG. 5, trouble ticket information 601 and pre-processed trouble ticket information 603 are historical trouble ticket information which may be provided at various levels of granularity (e.g., for a particular customer for which a trouble ticket is being processed for device problem classification, for a set of customers of a particular access network, for a set of customers of a service provider, or the like). The pre-processing of trouble ticket information 601 by pre-processing process 602 to form pre-processed trouble ticket information 603 may include cleaning of trouble ticket information 601 (e.g., removal of punctuation marks, removal of stop-words, lower-casing of the text, or the like, as well as various combinations thereof).

In method 600, as indicated above, the text mining classification process 605 is configured to perform text mining on pre-processed trouble ticket information 603 (or, where pre-processing of trouble ticket information 601 is or does not need to be performed, on trouble ticket information 601) using regular expressions 604 to produce re-classified trouble ticket information 606. The regular expressions 604 may include special logical expressions written in a particular syntax (e.g., syntax specific to the software and processor currently being used). The text patterns may be composed of terms, text strings, phrases, clustering of terms or phrases (e.g., clustering within a particular field or set of fields, clustering within a set of fields within a threshold distance of each other, clustering within a particular number of words of each other within a free-form text field(s), or the like, as well as various combinations thereof), or the like, as well as various combinations thereof. The regular expressions 604 may include text patterns for all known device problem types or a subset of known device problem types. The regular expressions 604 may include mappings of text patterns to device problem types, respectively. The regular expressions 604 may be configured such that, for each device problem type available for classification of device problems of CPDs, the device problem type has one or more of the regular expressions 604 associated therewith (e.g., each device problem type has a single unique regular expression 604 associated therewith, each device problem type has one regular expression 604 associated therewith where a given regular expression 604 may be associated with multiple device problem types, each regular expression 604 has one device problem type associated therewith where a given device problem type may be associated with multiple regular expressions 604, or the like, as well as various combinations thereof). The regular expressions 604 may be represented as logical expressions having associated syntax. For example, a regular expression 604 represented as {[!educate(Id)] & no guid(|e)|img|media[̂manager]|(guide|img) not working} is configured to match text according to the following rules, must not include the word ‘educate’ or ‘educated’, must include the expression ‘no guid’ or ‘no guide’, or may contain the expression ‘img’, and so forth. In one embodiment, at least a portion of the regular expressions 604 may be generated as depicted and described with respect to FIG. 7. The text mining of pre-processed trouble ticket information 603 (or, again, where pre-processing of trouble ticket information 601 is or does not need to be performed, on trouble ticket information 601) using regular expressions 604 includes parsing of the pre-processed trouble ticket information 603 using regular expressions 604 to determine whether the pre-processed trouble ticket information 603 matches any of the regular expressions 604. In this manner, pre-processed trouble ticket information 603 may be evaluated to determine whether the pre-processed trouble ticket information 603 includes any information that matches one or more of the regular expressions 604. The text mining classification process 605 may be configured such that, based on a determination that the pre-processed trouble ticket information 603 does not match any of the regular expressions 604, additional processing is performed for classifying pre-processed trouble ticket information 603. The text mining classification process 605 may be configured such that, based on a determination that the pre-processed trouble ticket information 603 matches only one of the regular expressions 604, a classification or classifications associated with the one of the regular expressions 604 is associated with the pre-processed trouble ticket information 603 (or the matched part of the pre-processed trouble ticket information 603) to form thereby re-classified trouble ticket information 606. The text mining classification process 605 may be configured such that, based on a determination that the pre-processed trouble ticket information 603 matches more than one of the regular expressions 604, multiple classifications associated with the multiple regular expressions 604 are associated with the pre-processed trouble ticket information 603 (or the matched part of the pre-processed trouble ticket information 603) to form thereby re-classified trouble ticket information 606. The text mining classification process 605 may be configured such that, based on a determination that the pre-processed trouble ticket information 603 matches more than one of the regular expressions 604, a set of rules may be applied to resolve which classification or classifications associated with the multiple regular expressions 604 are to be associated with the pre-processed trouble ticket information 603 (or the matched part of the pre-processed trouble ticket information 603) to form thereby re-classified trouble ticket information 606. The re-classified trouble ticket information 606 includes an assignment of the trouble ticket to a specific pre-defined device problem (e.g., “Can't connect to the Internet”, “All Channels are Out”, or the like).

It will be appreciated that, although depicted and described as being part of method 600, pre-processing of trouble ticket information 601 to form pre-processed trouble ticket information 603 may be performed as a separate process(es) that may be executed well in advance of execution of other portions of method 600, immediately prior to execution of other portions of method 600, contemporaneously with execution of other portions of method 600, or the like.

The method 600 of FIG. 6 may be better understood by considering an exemplary implementation of method 600 within the context of FIG. 2. For example, within the context of FIG. 2, method 600 or portions of method 600 may be one of the TMPs 226, trouble ticket information 601 may be part of DPCII 222, regular expressions 604 may be part of REs 228, re-classified trouble ticket information may be maintained as part of DPCII 222 (e.g., for use as an input for one of the DPCPs 221, such as for use by method 400 of FIG. 4, method 500 of FIG. 5, or the like).

FIG. 7 depicts an embodiment of a method for training regular expressions based on trouble ticket information of a trouble ticket system. It will be appreciated that, although primarily depicted and described herein as being performed in a particular order, at least a portion of method 700 of FIG. 7 may be performed in a different order than depicted in FIG. 7. As noted above, method 700 of FIG. 7 may be used to create regular expressions 604 of FIG. 6 or may be used to create regular expressions for use within various other contexts.

In method 700 of FIG. 7, raw historical trouble ticket information 701 is processed by a pre-processing process 702 and an information classification process 703 to form the regular expressions 704 based on the raw historical trouble ticket information 701. The raw historical trouble ticket information may include a set of trouble tickets for which the device problem types of the trouble tickets is known. The pre-processing process 702 may be configured to perform cleaning of the raw historical trouble ticket information 701 (e.g., removal of punctuation marks, removal of stop-words, lower-casing of the text, or the like, as well as various combinations thereof). The information classification process 703 includes various actions adapted to classify portions of the raw historical trouble ticket information 701 in order to identity regular expressions 704, where such actions may include automated actions, manual actions, or the like, as well as various combinations thereof. For example, automated information classification actions may include automated parsing and processing of historical trouble ticket information (e.g., raw historical trouble ticket information 701, pre-processed historical trouble ticket information produced by pre-processing process 702, or the like, as well as various combinations thereof) in order to identify regular expressions 704. For example, manual information classification actions may include manual review and analysis of historical trouble ticket information (e.g., raw historical trouble ticket information 701, pre-processed historical trouble ticket information produced by pre-processing process 702, or the like, as well as various combinations thereof) by one or more users in order to identify regular expressions 704. The one or more uses may be human classification experts with knowledge and understanding of historical trouble ticket information and regular expressions 704 which may be derived therefrom. As depicted in FIG. 7 and discussed above, processing of raw historical trouble ticket information 701 to form the regular expressions 704 may include various forms of interaction between pre-processing process 702 and information classification process 703 (e.g., providing of pre-processed historical trouble ticket information generated by pre-processing process 702 as input to the information classification process 703, providing classification results from classification of historical trouble ticket information as part of information classification process 703 as input to the pre-processing process 702, or the like, as well as various combinations thereof). The regular expressions 704 generated based on the raw historical trouble ticket information 701 may include regular expressions that fit text that describes device problem types as determined from the raw historical trouble ticket information 701 (e.g., a given regular expression 704 fits text that describes a device problem type that maps to that given regular expression 704). In general, a given regular expression 704 generated based on the raw historical trouble ticket information 701 may include any suitable logical concatenation of text patterns indicating the occurrence of a specific device problem. The regular expressions 704 may include mappings of text patterns to device problem types, respectively. The regular expressions 704 may include text patterns for all known device problem types or a subset of known device problem types. The regular expressions 704 are configured for use in text mining on other sets of trouble ticket information (e.g., customer trouble ticket information, other sets of historical trouble ticket information, or the like). As depicted in FIG. 7, the regular expressions 704 may be further processed or refined to form optimal regular expressions 705, which may be used in the same manner as regular expressions 704 (e.g., in text mining as the regular expressions 604 of method 600 of FIG. 6).

In at least some embodiments, generation of the regular expressions 704 or the optimal regular expressions 705 may be performed in a manner tending to increase or optimize one or more performance measures of regular expression based text mining. The performance measures of regular expression based text mining may include coverage and purity. Here, performance measures of regular expression based text mining are discussed within the context of input information, which is to be evaluated using regular expression based text mining, including a set of trouble tickets. The coverage performance metric for a regular expression may be defined as a number of trouble tickets captured by the regular expression out of the set of trouble tickets classified by the information classification process 703 and associated with the device problem type of the regular expression. The purity performance metric for a regular expression may be defined as a fraction of correctly classified trouble tickets (classified based on information classification process 703) out of the total set of trouble tickets found based on the regular expression. In at least some embodiments, a regular expression 704 that is configured to maximize both coverage and purity is considered to be an optimal regular expression 705. In at least some embodiments, method 700 may be configured to generate regular expressions 704 or optimal regular expressions 705 while attempting to achieve least 50% coverage and at least 75% coverage (although it will be appreciated that other thresholds may be used).

It will be appreciated that, although depicted and described as being part of method 700, either or both of pre-processing process 702 or information classification process 703 may be performed as a separate process or processes that may be executed well in advance of execution of other portions of method 700, immediately prior to execution of other portions of method 700, contemporaneously with execution of other portions of method 700, or the like.

The method 700 of FIG. 7 may be better understood by considering an exemplary implementation of method 700 within the context of FIG. 2. For example, within the context of FIG. 2, method 700 or portions of method 600 may be one of the RETPs 227, raw historical trouble ticket information 601 may be part of DPCII 222, regular expressions 704 may be part of REs 228, and optimal regular expressions 705 may be part of REs 228.

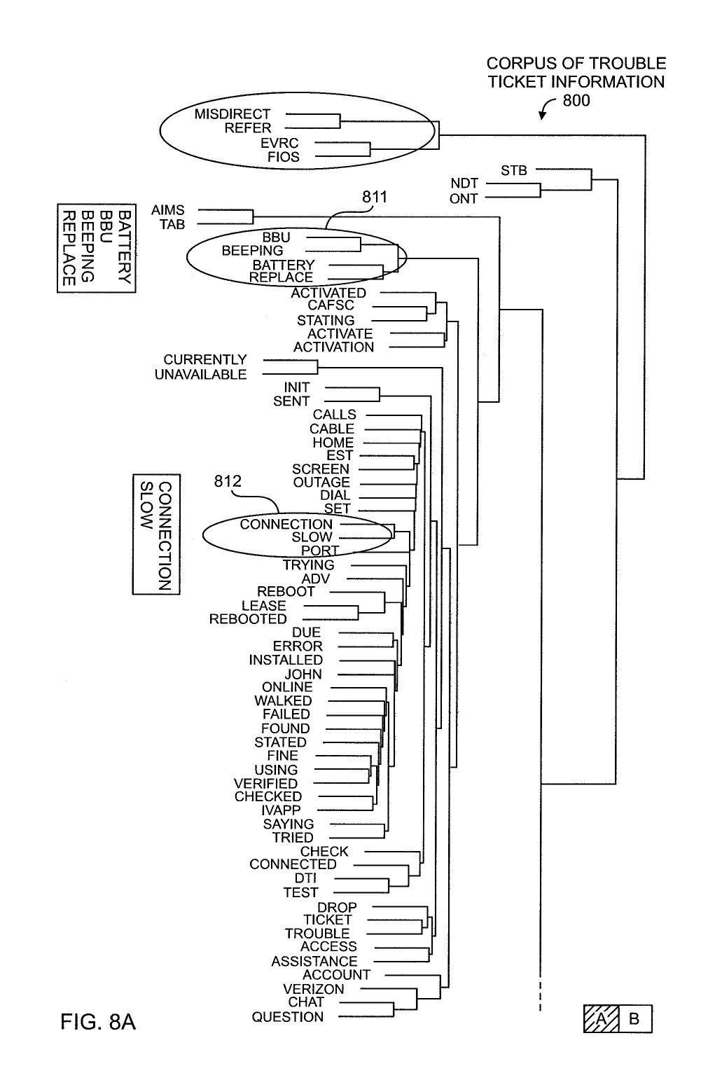

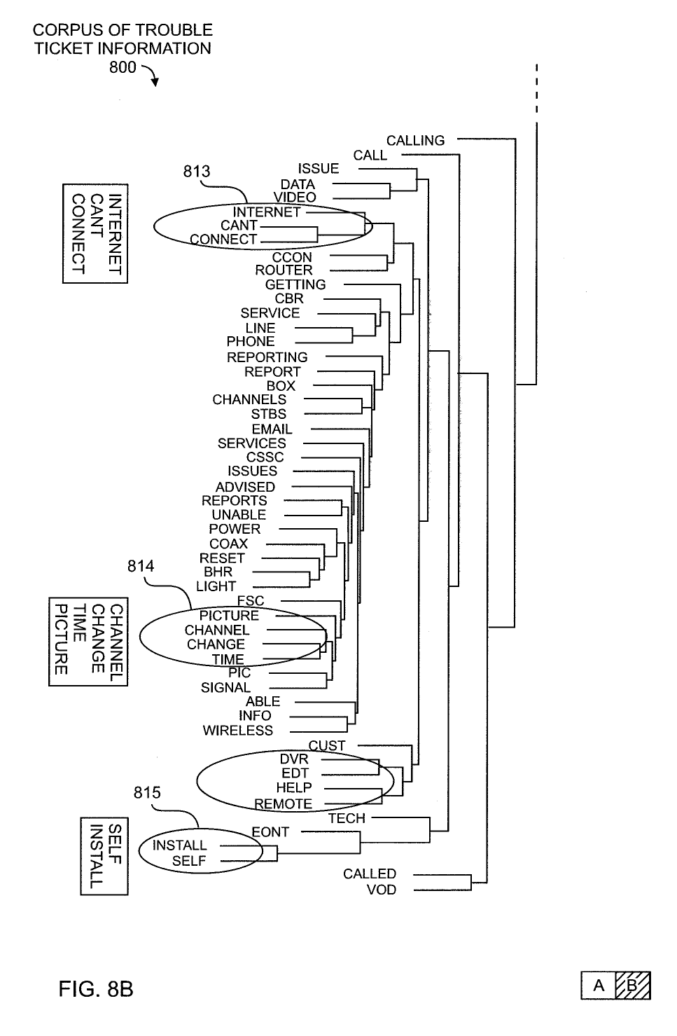

FIGS. 8A and 8B depict an exemplary corpus of trouble ticket information for a set of trouble tickets. As depicted in FIGS. 8A and 8B, corpus of trouble ticket information 800 includes a set of hierarchically arranged trouble parameters associated with the set of trouble tickets. As depicted in FIGS. 8A and 8B, certain combinations of values of certain parameters clustered in a particular way may be indicative of associated device problem types of particular CPDs. For example, a first set of values of a first set of parameters 811 is indicative of a problem with a battery of the CPD, a second set of values of a second set of parameters 812 is indicative of a slow connection, a third set of values of a third set of parameters 813 is indicative that an Internet connection cannot be obtained, a fourth set of values of a fourth set of parameters 814 is indicative of a particular channel change time, a fifth set of values of a fifth set of parameters 815 is indicative of a self-install operation, and so forth. The corpus of trouble ticket information 800 may be used to determine mappings of regular expressions to associated device problem types.

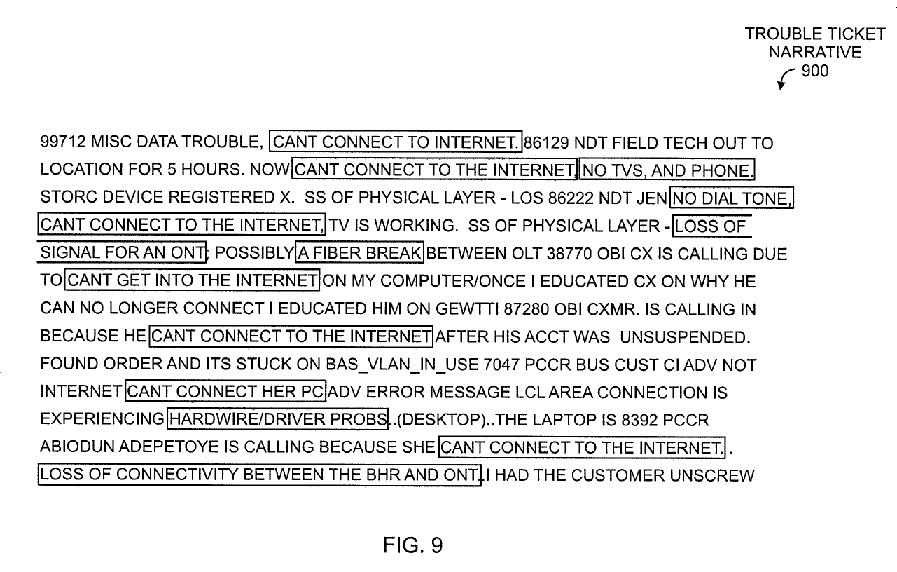

FIG. 9 depicts an exemplary trouble ticket narrative of a trouble ticket As depicted in FIG. 9, the trouble ticket narrative 900 may be processed to identify particular words or phrases, particular clusterings of words or phrases, or the like, as well as various combinations thereof. For example, various clusters of words highlighted in the trouble ticket narrative 900 are indicative that an Internet connection cannot be obtained or maintained. As illustrated in FIG. 9, the phrase “CANT CONNECT TO INTERNET”, or substantially similar variations thereof, occur six different times within the trouble ticket narrative 900. As further illustrated in FIG. 9, other similar terms or phrases (e.g., “LOSS OF SIGNAL FOR AN ONT”, “LOSS OF CONNECTIVITY BETWEEN THE BHR AND ONT”, and so forth) also are present within the trouble ticket narrative 900. The trouble ticket narrative 900 may be processed in order to train regular expressions, may be processed used text mining in order to identify regular expressions, or the like, as well as various combinations thereof.

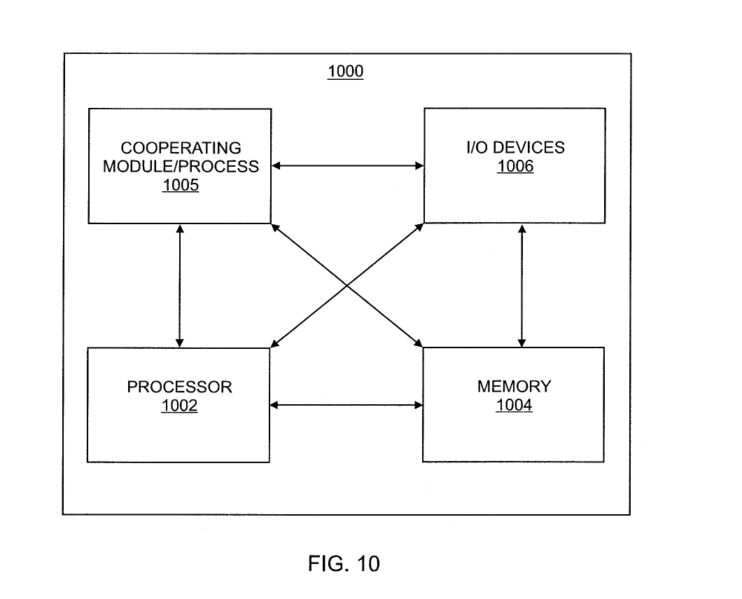

FIG. 10 depicts a high-level block diagram of a computer suitable for use in performing functions described herein.

The computer 1000 includes a processor 1002 (e.g., a central processing unit (CPU) and/or other suitable processor(s)) and a memory 1004 (e.g., random access memory (RAM), read only memory (ROM), and the like) that is communicatively connected to the processor 1002. The memory 1004 may store programs, data, or the like, which may be loaded into processor 1002 and executed by processor 1002 to provide various functions as discussed herein.

The computer 1000 also may include a cooperating module/process 1005. The cooperating process 1005 can be loaded into memory 1004 and executed by the processor 1002 to implement functions as discussed herein and, thus, cooperating process 1005 (including associated data structures) can be stored on a computer readable storage medium, e.g., RAM memory, magnetic or optical drive or diskette, and the like.

The computer 1000 also may include one or more input/output devices 1006 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 1000 depicted in FIG. 10 provides a general architecture and functionality suitable for implementing functional elements described herein and/or portions of functional elements described herein. For example, computer 1000 provides a general architecture and functionality suitable for implementing one or more of a CPD 112, a portion of a CPD, DMS 120, a portion of DMS 120, TTS 130, a portion of TTS 130, DPCS 140, a portion of DPCS 140, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
receive customer trouble ticket information of a trouble ticket associated with a customer;
receive customer device measurement information for a customer premises device of the customer; and
classify a device problem of the customer premises device based on text mining of the customer trouble ticket information and based on the customer device measurement information.

2. The apparatus of claim 1, wherein, to classify the device problem of the customer premises device, the processor is configured to:
perform text mining of the customer trouble ticket information for attempting to classify the device problem of the customer premises device; and
based on a determination that the device problem of the customer premises device cannot be classified based on the text mining of the customer trouble ticket information, classify the device problem of the customer premises device based on the customer device measurement information.

3. The apparatus of claim 2, wherein the text mining of the customer trouble ticket information is based on a set of regular expressions determined from historical trouble ticket information.

4. The apparatus of claim 2, wherein, to classify the device problem of the customer premises device based on the customer device measurement information, the processor is configured to:
process the customer device measurement information, based on a device measurement classification model, to form classified customer device measurement information; and
classify the device problem of the customer premises device based on the classified customer device measurement information.

5. The apparatus of claim 4, wherein the device measurement classification model comprises a reference mapping, wherein the reference mapping includes a mapping between a set of device measurements from historical device measurement information and a device problem type associated with the set of device measurements from the historical device measurement information.

6. The apparatus of claim 5, wherein, to process the customer device measurement information to form the classified customer device measurement information, the processor is configured to:
identify the reference mapping, from the device measurement classification model, based on a determination that the set of device measurements of the reference mapping corresponds to at least a portion of the customer device measurement information; and
form the classified customer device measurement information by modifying the customer device measurement information to include the device problem type from the reference mapping of the device measurement classification model.

7. The apparatus of claim 5, wherein, to classify the device problem of the customer premises device based on the classified customer device measurement information, the processor is configured to:
identify the device problem type from the classified customer device measurement information.

8. The apparatus of claim 1, wherein, to classify the device problem of the customer premises device, the processor is configured to:
determine fused customer information comprising a fusion of the customer device measurement information and text-mined customer trouble ticket information generated based on the customer trouble ticket information;
determine a fused historical information classification model; and
classify the device problem of the customer premises device based on the fused customer information and the fused historical information classification model.

9. The apparatus of claim 8, wherein, to generate the text-mined customer trouble ticket information, the processor is configured to:
identify a set of regular expressions matching portions of the customer trouble ticket information; and
generate the text-mined customer trouble ticket information based on the identified set of regular expressions.

10. The apparatus of claim 9, wherein the customer trouble ticket information comprises one or more trouble ticket narratives, wherein, to identify the set of regular expressions matching portions of the customer trouble ticket information, the processor is configured to:
identify a set of pre-defined regular expressions; and
search the one or more trouble ticket narratives based on the set of pre-defined regular expressions;
wherein the set of regular expressions matching portions of the customer trouble ticket information includes one or more of the pre-defined regular expressions identified in the one or more trouble ticket narratives.

11. The apparatus of claim 9, wherein, to determine the fused customer information, the processor is configured to:
determine, from the customer device measurement information, a set of device measurements for the customer premises device; and
determine the fused customer information by creating one or more mappings between the set of regular expressions of the text-mined customer trouble ticket information and the set of device measurements of the customer device measurement information.

12. The apparatus of claim 8, wherein, to determine the fused historical information classification model, the processor is configured to:
determine fused historical information comprising one or more mappings between one or more sets of device measurements from historical device measurement information and one or more sets of regular expressions from text-mined historical trouble ticket information; and
determine the fused historical information classification model by, for each of the one or more mappings, identifying a device problem type associated with the respective mapping and associating the identified device problem type with the respective mapping.

13. The apparatus of claim 12, wherein, to determine the fused historical information, the processor is configured to:
determine the historical device measurement information, the historical device measurement information comprising the one or more sets of device measurements;
determine the text-mined historical trouble ticket information based on text mining of historical trouble ticket information; and
determine the fused historical information by creating the one or more mappings between the one or more sets of device measurements and the text-mined historical trouble ticket information.

14. The apparatus of claim 13, wherein to determine the text-mined historical trouble ticket information, the processor is configured to:
determine the historical trouble ticket information, the historical trouble ticket information comprising one or more trouble ticket narratives of one or more trouble tickets; and
determine the text-mined historical trouble ticket information by performing text mining on the one or more trouble ticket narratives to identify the one or more sets of regular expressions.

15. The apparatus of claim 14, wherein, to determine the text-mined historical trouble ticket information by performing text mining on the one or more trouble ticket narratives, the processor is configured to:
identify a set of pre-defined regular expressions; and
search the one or more trouble ticket narratives based on the set of pre-defined regular expressions;
wherein the one or more sets of regular expressions include one or more of the pre-defined regular expressions identified in the one or more trouble ticket narratives.

16. The apparatus of claim 8, wherein, to classify the device problem of the customer premises device based on the fused customer information and the fused historical information classification model, the processor is configured to:
identify, from the fused customer information, a mapping of a set of regular expressions matching portions of the text-mined customer trouble ticket information to a set of device measurements from the customer device measurement information;
identify, from the fused historical information classification model, a reference mapping similar to the mapping of the set of regular expressions matching portions of the text-mined customer trouble ticket information to the set of device measurements from the customer device measurement information; and
determine the device problem of the customer premises device from the identified reference mapping.

17. The apparatus of claim 8, wherein, to determine the fused customer information, the processor is configured to:
create a mapping between a set of regular expressions of the text-mined customer trouble ticket information and a set of device measurements from the customer device measurement information.

18. The apparatus of claim 17, wherein, to determine the fused historical information classification model, the processor is configured to:
create a set of reference mappings, each reference mapping comprising:
a set of regular expressions matching portions of historical trouble ticket information;
a set of device measurements, associated with the set of regular expressions matching portions of the historical trouble ticket information, from historical device measurement information; and
a device problem type associated with the set of regular expressions and the set of device measurements.

19. The apparatus of claim 18, wherein, to classify the device problem of the customer premises device, the processor is configured to:
search the set of reference mappings to identify one of the reference mappings similar to the mapping between the set of regular expressions of the text-mined customer trouble ticket information and the set of device measurements from the customer device measurement information; and
determine the device problem of the customer premises device from the identified one of the reference mappings.

20. The apparatus of claim 1, wherein the processor is configured to classify the device problem of the customer premises device based on at least one of:
a fusion of the customer trouble ticket information and the customer device measurement information; or
a fusion of historical trouble ticket information and historical device measurement information.

21. A method, comprising:
using a processor and a memory for:
receiving customer trouble ticket information of a trouble ticket associated with a customer;
receiving customer device measurement information for a customer premises device of the customer; and
classifying a device problem of the customer premises device based on text mining of the customer trouble ticket information and based on the customer device measurement information.

22. A computer-readable storage medium storing instructions which, when executed by a computer, cause the computer to perform a method, the method comprising:
receiving customer trouble ticket information of a trouble ticket associated with a customer;
receiving customer device measurement information for a customer premises device of the customer; and
classifying a device problem of the customer premises device based on text mining of the customer trouble ticket information and based on the customer device measurement information.
